(19) United States
(12) Patent Application Publication
(10) Pub. No.: US 2002/0062753 A1
(43) Pub. Date: May 30, 2002

(54) Printing blanket for offset printing applications

(76) Inventor: Joachim Herrmann, Northeim (DE)

Correspondence Address: Walter Ottesen, Patent Attorney, P.O. Box 4026, Gaithersburg, MS, 20885-4026, US

(21) Appl. No.: 09/992,014

(22) Filed: Nov. 26, 2001

(30) Foreign Application Priority Data
Nov. 24, 2000 (EP) 0012577.7

(51) Int. Cl. B41F 13/10; B41F 27/06

(52) U.S. Cl. 101/376

(57) ABSTRACT

The invention is directed to a printing blanket for offset printing applications, preferably for use for printing on surface structured and especially deformation endangered printing materials. The printing blanket includes a base layer (1) assigned to the printing cylinder, a compressible intermediate layer (2) having closed gas pores (5) and having an outer-lying outer layer (3) facing toward the printing material. The compressible intermediate layer (2) and the outer layer (3), which faces toward the printing material, are so dimensioned that the force, which acts on the printing blanket during the printing operation, leads to a deformation of the composite of compressible intermediate layer (2) and outer layer (3) so that a full-area contact of the printing blanket on the printing material is achieved as well as a uniform distribution of the local pressure.

### FIELD OF THE INVENTION

The invention relates to a printing blanket for offset printing applications, preferably for printing on surface structured materials and especially for printing on printing materials which can be deformed.

### BACKGROUND OF THE INVENTION

In the past, printing blankets have always been adapted to special uses. Difficulties arise always when the reaction force, which originates from the printing cylinder and acts on the printing blanket, is not constant over time. This is normally the case when printing on structured printing material. Furthermore, printing materials exist such as cartons, corrugated paper or the like wherein forces occur in connection with the printing operation and these forces lead to changes in the form of the printing materials whereby the printing result is negatively influenced over the entire surface, for example, with respect to a register-content printing.

A printing blanket of an elastic compressible print element having a closed-cell foam is described in German patent publication 3,027,549. The configuration of such a printing blanket is suitable for lithographic printing; in contrast, the printing blanket is not useable for applications to print structured surfaces when high requirements as to quality are to be satisfied.

### SUMMARY OF THE INVENTION

It is an object of the invention to provide a printing blanket for offset printing with which special application cases can be realized with respect to the selection of the particular printing material.

The printing blanket of the invention is for offset printing applications including for printing a surface structured printing material including a printing material having a tendency to deform. The printing blanket includes: a base layer allocated to a printing cylinder; a compressible intermediate layer disposed atop the base layer; an outer layer facing toward the printing material and being disposed adjacent the intermediate layer; the compressible intermediate layer being configured as an elastomeric layer or as a thermoplastic elastomeric layer and being connected to the outer layer so as to form a composite therewith; the outer layer having a thickness considerably less than the thickness of the compressible intermediate layer; and, the outer layer having an elasticity and the intermediate layer having a compression performance which are so selected that the force acting on the printing blanket during a printing operation deforms the composite so as to cause a full surface contact engagement of the printing blanket on the printing material and a uniform distribution of pressure.

The invention affords the advantage that the relevant surface regions of the printing blanket come into defined large area contact with the printing material without subjecting the printing material to forces which would lead to a non-reversible deformation of the printing material. This advantage comes about as a consequence of a comparatively intense elastically deformable outer layer and an intermediate layer which yields elastically during the printing operation in the compressed state. Local unevenness of the printing material leads only to slight differences in the print pressing if at all. In this way, a uniform printing result is ensured.

According to an embodiment of the invention, the parameters of the intermediate layer configured with closed pores (such as thickness of the layer, pore portion and pore size) are so selected that, for the application of a test pressure of 1,350 kPa, a thickness reduction of 20 to 50% of the initial thickness of the printing blanket is achieved. With such an intermediate layer, the precondition for an elastic adaptation of the outer layer to the profile of the printing material is provided.

The thickness of the printing blanket can be selected to be greater than 2.0 mm. Especially good printing results can be obtained when the thickness of the printing blanket lies in the range of 2.5 to 3.0 mm.

In a further embodiment of the invention, and for a use of the printing blanket for printing materials such as corrugated paper, the pore portion of the compressible intermediate layer is so selected that a reduction of the thickness of the printing blanket by 0.45 to 0.90 mm takes place under the action of a test pressure of 1,350 kPa. A further improvement of the printing quality is achievable for a pore portion in the intermediate layer which leads to a reduction of the thickness of the printing blanket by 0.55 to 0.70 mm for a test pressure of 1,350 kPa.

NBR mixtures, polyurethane or other elastomers can be used for the compressible intermediate layer.

The base layer of the printing blanket advantageously includes a reinforcement of cotton. Preferably, the reinforcements, which can also be made of other materials, can be introduced in the form of two fabric layers.

In a further embodiment of the invention, the thickness of the compressible intermediate layer is 1 to 2 mm. The ratio of the thickness of the outer layer to the thickness of the compressible intermediate layer can be in the range of 1:2.5 up to 1:7.

The outer layer advantageously has a Shore hardness of less than 55 ShA for obtaining high quality printing results especially when printing on printing materials which tend to deform.

Furthermore, a fabric having a high elasticity can be embedded in a compensating layer. The expansion is greater than 7% for a loading of 500 N/5 cm.

### BRIEF DESCRIPTION OF THE DRAWING

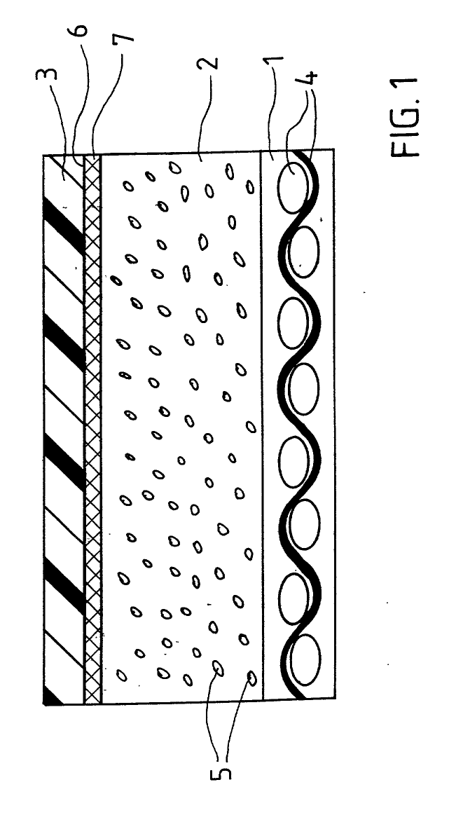

The invention will now be described with respect to the single figure (FIG. 1) of the drawing which shows, in section, a printing blanket for printing on corrugated paper and similar printing materials.

### DESCRIPTION OF THE PREFERRED EMBODIMENTS OF THE INVENTION

The layer build-up of the printing blanket is shown in FIG. 1 and includes essentially a base layer 1, a compressible intermediate layer 2, and a cover rubber layer 3 facing toward the printing material. A reinforcement 4 in the form of a two-layer cotton fabric is introduced into the base layer 1. However, other reinforcements such as foils, sheet metal and fabric of other materials as well as non-woven fabric can also be introduced as a component of the base layer 1. The compressible intermediate layer 2 is contiguous with the base layer 1 and has gas pores 5 which are closed upon themselves. These pores ensure an adequately high compressibility of the intermediate layer 2.

The intermediate layer 2 is joined to the cover rubber layer 3 via an adhesive coating or film 6 and/or a compensating layer 7 in which a fabric layer can be embedded. The cover rubber layer 3 has only a slight thickness and high elasticity so that the surface thereof can adapt adequately well to the profile of the printing material during the printing operation.

An adequately intensive and reproducible transfer of printing ink is achieved on the basis of the applied force of the cover rubber layer 3 against the printing material for a time relevant to the printing operation. The applied force starts from the compressed intermediate layer 2 and is distributed relatively uniformly. A printing image arises, which, in the result, satisfies high requirements also for surface structured or deformation endangered printing materials.

It is understood that the foregoing description is that of the preferred embodiments of the invention and that various changes and modifications may be made thereto without departing from the spirit and scope of the invention as defined in the appended claims.

What is claimed is:

1. A printing blanket for offset printing applications including for printing a surface structured printing material including a printing material having a tendency to deform, the printing blanket comprising:
a base layer allocated to a printing cylinder;
a compressible intermediate layer disposed atop said base layer;
an outer layer facing toward the printing material and being disposed adjacent said intermediate layer;
said compressible intermediate layer being configured as an elastomeric layer or as a thermoplastic elastomeric layer and being connected to said outer layer so as to form a composite therewith;
said outer layer having a thickness considerably less than the thickness of said compressible intermediate layer; and, said outer layer having an elasticity and said intermediate layer having a compression performance which are so selected that the force acting on said printing blanket during a printing operation deforms said composite so as to cause a full surface contact engagement of said printing blanket on the printing material and a uniform distribution of pressure.

2. The printing blanket of claim 1, wherein said intermediate layer is bonded directly to said outer layer with a bonding agent.

3. The printing blanket of claim 2, wherein said compressible intermediate layer includes closed pores formed therein.

4. The printing blanket of claim 3, wherein the number of said closed pores and said thickness of said intermediate layer are so selected that a thickness reduction of 20 to 50% of the initial thickness of said printing blanket is obtained when a test pressure of 1,350 kPa is applied thereto.

5. The printing blanket of claim 4, wherein said thickness of said printing blanket is selected to be greater than 2.0 mm.

6. The printing blanket of claim 5, wherein said thickness of said printing blanket is selected to be in the range of 2.5 to 3.0 mm.

7. The printing blanket of claim 5, wherein a reduction of the thickness of said printing blanket of 0.45 to 0.90 mm results from an application of said test pressure of 1,350 kPa.

8. The printing blanket of claim 2, wherein said compressible intermediate layer has a thickness in the range of 1 to 2 mm.

9. The printing blanket of claim 2, wherein the ratio of the thickness of said outer layer to the thickness of the compressible intermediate layer lies in the range of 1:2.5 to 1:7.

10. The printing blanket of claim 2, wherein said outer layer has a Shore hardness of less than 55 ShA.

11. The printing blanket of claim 1, further comprising a compensating layer; and, said intermediate layer being connected to said outer layer with said compensating layer being disposed therebetween.

12. The printing blanket of claim 11, wherein said compensating layer has a fabric embedded therein and said fabric has a high elasticity.

13. The printing blanket of claim 12, wherein said elasticity of said fabric is greater than 7% under a load of 500 N/5 cm.

14. The printing blanket of claim 11, wherein said compressible intermediate layer includes closed pores formed therein.

15. The printing blanket of claim 14, wherein the number of said closed pores and said thickness of said intermediate layer are so selected that a thickness reduction of 20 to 50% of the initial thickness of said printing blanket is obtained when a test pressure of 1,350 kPa is applied thereto.

16. The printing blanket of claim 15, wherein said thickness of said printing blanket is selected to be greater than 2.0 mm.

17. The printing blanket of claim 16, wherein said thickness of said printing blanket is selected to be in the range of 2.5 to 3.0 mm.

18. The printing blanket of claim 16, wherein a reduction of the thickness of said printing blanket of 0.45 to 0.90 mm results from an application of said test pressure of 1,350 kPa.

19. The printing blanket of claim 11, wherein said compressible intermediate layer has a thickness in the range of 1 to 2 mm.

20. The printing blanket of claim 11, wherein the ratio of the thickness of said outer layer to the thickness of the compressible intermediate layer lies in the range of 1:2.5 to 1:7.

21. The printing blanket of claim 11, wherein said outer layer has a Shore hardness of less than 55 ShA.
